(19) United States
(12) Patent Application Publication
(10) Pub. No.: US 2007/0292963 A1
(43) Pub. Date: Dec. 20, 2007

(54) OPTICAL DETERMINATION OF SERUM COMPONENTS FOR CANCER SCREENING

(76) Inventors: Bryan D. Dickerson, Blacksburg, VA (US); Brian L. Geist, Pulaski, VA (US); John L. Robertson, Floyd, VA (US); William B. Spillman JR., Floyd, VA (US)

Correspondence Address: BLANK ROME LLP, 600 NEW HAMPSHIRE AVENUE, N.W., WASHINGTON, DC, 20037, US

(21) Appl. No.: 11/757,672

(22) Filed: Jun. 4, 2007

Related U.S. Application Data
(60) Provisional application No. 60/810,168, filed on Jun. 2, 2006.

(51) Int. Cl. G01N 21/00

(52) U.S. Cl. 436/164

(57) ABSTRACT

A method for determining the presence and concentration of components in serum includes the steps of providing a serum sample, performing optical analysis of the serum sample using a spectrometer to provide spectral data based on optical properties of the serum sample, determining the concentrations of albumin, globulins and hemoglobin in the serum sample based on comparisons of the spectral data with reference spectra and outputting the determined concentrations of the albumin, globulins and hemoglobin. The invention can be used to accurately determine the concentration of albumin, globulins and hemoglobin in blood serum and can form the basis of initial cancer screening and to gauge a patient's response to treatment.

### STATEMENT OF PRIORITY

This application claims priority to U.S. Provisional Patent Application Ser. No. 60/810,168 filed Jun. 2, 2006, which is hereby incorporated by reference in its entirety.

### BACKGROUND OF THE INVENTION

1. Field of the Invention

This invention relates generally to a method for determining the presence and concentration of components in serum in medical diagnoses. The invention also relates to an optical method for accurately determining the concentration of albumin, globulins and hemoglobin in blood serum.

2. Background of the Related Art

Nearly one fourth of all deaths in the United States are caused by cancer. See, for example, R. S. Cotran et al., eds., Robbins Pathological Basis of Disease, W.B. Saunders Co., (1999) pp. 260-327. In 2004, over 500,000 Americans died from cancer. Early detection and treatment improves the odds of patient survival. Oncologists have repeatedly sought a universal cancer marker. Recently, unique sets of indicator proteins have been used to identify specific malignancies. To this end, proteomic methods, including various hybrid forms of mass spectroscopy (see, for example, R. Aebersold et al., “Mass Spectroscopy-Based Proteomics,” Nature (2003) vol. 422, March 13, pp. 198-207 and J. Li et al., Proteomics and Bioinformatics Approaches for Identification of Serum Biomarkers to Detect Breast Cancer,” Clinical Chemistry (2002) vol. 48, pp. 1296-1304) and fluorescent conjugated with antibodies or DNA sequences (see, for example, A. Statnikov et al., “A Comprehensive Evaluation of Multicategory Classification Methods for Microarray Gene Expression Cancer Diagnosis,” Bioinformatics (2005) vol. 21, pp. 1296-1304), have been developed to help pinpoint cancer diagnoses. However, the specificity of tests, the cost of analysis, and the low availability of specialized equipment for proteomics, make them less practical as general cancer screening tools. Presently, tissue autofluorescence and endoscopy can highlight tumors located in the skin, cervix, longs, bladder, prostrate and colon. Here, the invasive nature of these tests makes them impractical for cancer screening except in high risk populations.

There are good reasons to focus on blood composition for early detection of cancer. Many forms of cancer disturb local vascular structure and trigger systemic immune responses via the blood. See, for example, B. F. Feldman et al., eds., Schalm's Veterinary Hematology, 5^{th} Ed., Lippincott Williams & Wilkins, (2000) pp. 565-570, 899-903. Therefore, serum levels of globulins, albumin and hemoglobin metabolites may be modified by the presence of various neoplasia.

For example, CV fluorescence spectroscopy has characterized higher serum levels of α₂-globulins at the expense of albumin in patients with malignancies. See, for example, M. R. Hubmann et al., “Ultraviolet Fluorescence of Human Sera: I. Sources of Characteristic Differences in Ultraviolet Fluorescence Spectra from Sera of Normal and Cancer-bearing Patients,” Clinical Chemistry (1990) vol. 36, pp. 1880-1883. During acute inflammation associated with tumor growth and necrosis, α-globulins are released in response to cytokines like the tumor necrosis factor. Elevated β-globulin levels and monoclonal γ-globulin levels are often observed with multiple myeloma and lymphoma. An increase in C-reactive protein (a β-globulin) may occur as the body regulates inflammation in response to cancer. The prolonged growth of tumors may also increase the levels of γ-globulins IgG, IgA and IgM.

The relationship between serum albumin and cancer is less clear. Albumin synthesis in the liver increases about 40% in cancer patients who experience a wasting of body mass, but cancer is often associated with low serum albumin levels. Changes in major protein levels (like albumin and globulins) due to cancer seem to be more consistent with a whole-body response, rather than with local over expression of specific proteins by tumor cells. See, for example, S. Welle, Human Protein Metabolism, Springer (1999) p. 204.

If tumors induce hemorrhage or weaken red blood cells walls, hemoglobin is released into the blood. Because it quickly binds to blood proteins, free hemoglobin is not expected to be observed at meaningful levels in normal serum or plasma. See, for example, R. J. Henry et al., eds., Clinical Chemistry Principles and Techniques, 2^{nd} Ed., Harper & Row (1974) pp. 449, 1071-2, 1117, 1239. Instead, there may be more haptoglobin-hemoglobin complexes, which could use up haptoglobin if hemolysis is severe.

If high pH within the tumors alters serum pH, then the spectra of hemoglobin complexes (such as methemalbumin) may be modified. Related to hemoglobin, porphyrin can accumulate in tissue and serum if tumors alter iron metabolism. See, for example, M. Kondo et al., “Heme Biosynthetic Enzyme Activities and Porphyrin Accumulation in Normal Liver and Hepatoma Cell Lines of Rat,” Cellular Biology Toxins (1993) vol. 9, pp. 95-105, R. Beri et al., “Chemistry and Biology of Heme: Effect of Metal Salts, Organometals, Metalloproteins on Heme Synthesis and Catabolism, with Special Reference to clinical Implications and Interactions with Cytochrome P-450,” Drug Met Rev (1993) vol. 25, 49-152 and B. R. Munson et al. “A Review: Biochemical Alterations Associated with Mouse Spleen Cells Infected with Friend Virus,” J Med (1973) vol. 4, pp. 354-370. The well-known strong autofluoresence of porphyrin facilitates the visual detection of colon cancer and other malignancies, under UV light. See, for example, T. S. Mang et al., “Fluorescence Detection of Tumors,” Cancer (1993) vol. 71, pp. 269-276, D. M. Harris et al., “Endogenous Porphyrin Fluorescence in Tumors,” Laser Surgery Medicine (1987) vol. 7, pp. 467-472, and P. Jichlinski et al. “Clinical Evaluation of a Method for Detecting Superficial Transitional cell Carcinoma of the Bladder by Light-Induced Fluorescence of Protoporphyrin 1× Following Topical Application of 5-aminolevulinic acid,” Laser Surgery Medicine (1997) vol. 20, pp. 402-408.

Each of the chemical pathways described above could provide opportunities to optically screen patients for cancer and monitor their response to therapy. Current quantitative techniques of albumin, globulins and hemoglobin in serum are limited in their accuracy, leading various facilities to quote different normal ranges, and resulting in disclaimers against comparing results between different labs. Modern standard methods of measuring hemoglobin are designed for whole blood and are not intended to detect minute hemoglobin levels in serum. For cancer screening, medical laboratories need more accurate methods of estimating these serum components.

### SUMMARY OF THE INVENTION

In one aspect, the invention relates to a method for determining the presence and concentration of components in serum. The method includes the steps of providing a serum sample, performing optical analysis of the serum sample using a spectrometer to provide spectral data based on optical properties of the serum sample, determining concentrations of albumin, globulins and hemoglobin in the serum sample based on comparisons of the spectral data with reference spectra and outputting the determined concentrations of the albumin, globulins and hemoglobin.

In preferred embodiments, the serum sample is a blood serum and the determining step includes determining concentrations of albumin, globulins and hemoglobin in the blood serum. The method may also include comparing the determined concentrations of the components with concentrations of the components obtained previously and evaluating a patient's response to treatment, based on the comparison of the determined concentrations with the concentrations of the components obtained previously

These and other objects of the invention, as well as many of the intended advantages thereof will become more readily apparent when reference is made to the following description, taken in conjunction with the accompanying drawings.

### BRIEF DESCRIPTION OF THE FIGURES

The accompanying drawings are not intended to be drawn to scale. In the drawings, each identical or nearly identical component that is illustrated in various figures is represented by a like numeral. For purposes of clarity, not every component may be labeled in every drawing.

FIG. 1 provides a graph illustrating the absorbance spectra of reference solutions;

FIG. 2 provides a graph illustrating the fluorescence spectra of reference solutions;

FIG. 3 illustrates the saturation of the fluorescence of serum components due to reabsorbance;

FIG. 4 provides a graph illustrating spectroscopic analysis of known mixtures;

FIG. 5 provides a graph illustrating spectroscopic estimates of albumin concentration;

FIG. 6 provides a graph illustrating spectroscopic estimates of globulin concentration;

FIG. 7 provides a graph illustrating spectroscopic estimates of total protein;

FIG. 8 provides a graph illustrating spectroscopic estimates of trace hemoglobin levels;

FIG. 9 illustrates the fitting of typical serum spectra;

FIG. 10 illustrates scattering contributions to serum absorbance spectra;

FIG. 11 illustrates the process of tracking changes in canine serum composition;

FIG. 12 illustrates a graph used in medical screening;

FIG. 13 illustrates a graph used in medical screening;

FIG. 14 illustrates spectroscopic analysis system, according to one embodiment of the instant invention.

FIG. 15 shows a comparison of absorption spectra obtained from chickens with or without Marek's tumors.

FIG. 16 shows a comparison of absorption spectra obtained from dogs with or without cancer.

FIG. 17 shows an overlay of a spectrum obtained from a dog with cancer and the textbook values for absorbances of various serum proteins.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

The present invention is directed to an optical method developed for accurately determining the concentration of albumin, globulins and hemoglobin in blood serum. This optical test method initially assumed that the near UV absorbance spectra of dilute serum in water could be fit as a linear combination of the component reference spectra. The scaling factors for each component that provided the best overall fit to the measured spectra were first approximations of each component's concentration. Accuracy was improved by applying appropriate correction factors, by accounting for turbidity, and by fitting normalized fluorescence spectra as well.

This analytical method has proven to be a sensitive way to track changes in serum composition over time to monitor the progression of cancer and to evaluate a patient's response to therapy. This technique successfully screened dogs for cancer (with 30% false negative and 20% false positive results) based on the following criteria: If serum free hemoglobin levels were below 0.2 g/L, and the total protein (albumin plus globulins) levels were between 70 and 125 g/L, and simultaneously the albumin level was not between 40 and 80 g/L, nor was the globulin level between 17 and 37 g/L, then these conditions were a serious preliminary indication of possible cancer and warranted a more thorough examination.

Until a tumor of a certain size (>1 cm) or location is clinically detected, there are few, if any, general indicators of occult cancer. Many specific protein expression assays have been developed to detect specific carcinomas, but only a few are in routine use. The spectroscopic method for analyzing serum composition, according to the present invention, is about the same cost as standard blood chemistry tests, but requires less blood volume, and is more accurate (especially in the determination of trace levels of hemoglobin in serum). These features suggest its potential use as a cancer screening tool based on the quantification of serum albumin, globulins and hemoglobin levels.

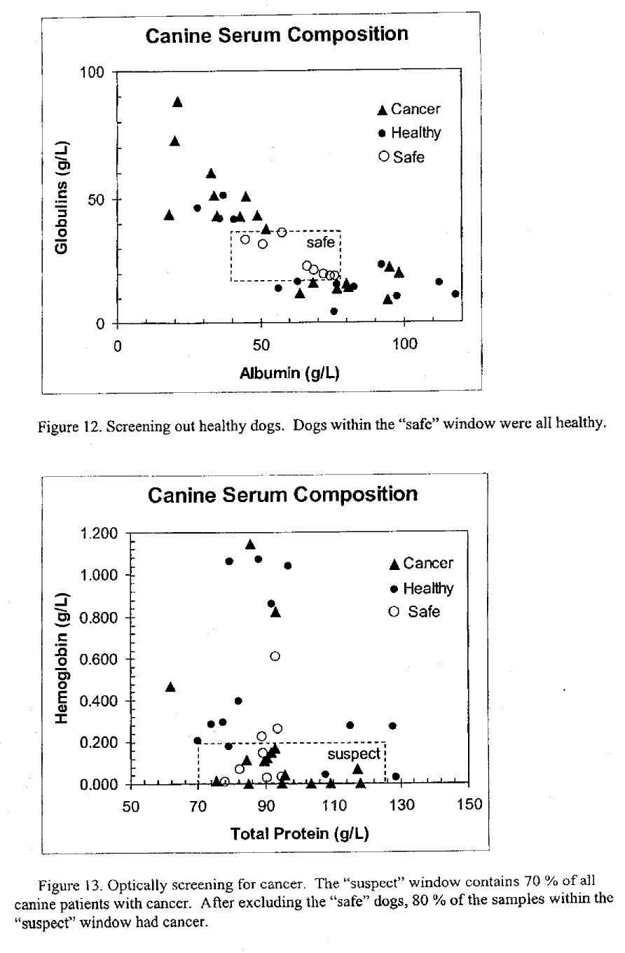

In one embodiment, the screening tool of the present invention involves the development of a database of subjects having or not having a specific disease. For example, samples may be taken from multiple subjects having a clinical diagnosis of having or not having a specific disease. The specific ratios of globulins, albumin, hemoglobin and total blood protein may be correlated with whether or not the subject has a specific disease. Further, once the database is developed, it may be used to correlate a subject with a predilection towards a specific disease, even though clinical symptoms of the disease have not manifested. A specific embodiment of how this type of pattern may be developed in shown in FIGS. 12 and 13 and in the description of these figures below.

It is further contemplated that other embodiments of the present invention may be used for diagnosing specific forms of cancer or other diseases. This diagnosis may be done through the detection of proteins different than the ones described herein, through the detection of different changes in concentration of the proteins described herein. Once a change in the absorption characteristics of samples over time is shown to correlate with a specific disease state, this correlation can be used to determine whether or not a subject has a case of the specific disease and how that disease is progressing in the subject.

Dogs are considered to be a good model of some types of human cancer and its response to therapy. Canine breast cancer has many parallels to human mammary carcinoma presentation. See, for example, L. Pena et al., “Canine Inflammatory Mammary Carcinoma: Histopathology, Immunohistochemistry and Clinical Implications of 21 Cases,” Breast Cancer Research Treatment (2003) vol. 78, No. 2, pp. 141-8. Furthermore, serum globulin and albumin levels are generally near 3 wt. % in dogs and in humans. Therefore, canine populations were chosen to test the feasibility of using spectroscopic analysis for cancer screening. In a preliminary trial involving serum from 60 dogs, the affordable optical method was sufficiently sensitive and specific to allow detection of serum analyte variations associated with neoplastic disease.

In describing the present invention, the development and use of the spectroscopic analysis system is discussed, then the use of the present invention in the analysis of serum compositions is discussed and finally the present invention is compared with other conventional assay methods.

To avoid spectral distortion and to optimize the signal to noise ratio, solutions were analyzed in a PMMA cuvette measuring 1×1×3.5 cm inside, i.e. the absorbance path length was 1 cm. Any transparent, non-fluorescing material is suitable for the cuvette; however, cuvettes with smaller cross-sections yield higher noise and require more concentrated serum. Serum and reference solution concentrations were adjusted so that the absorbance near 278 nm was between 1.5 and 0.3.

Fluorescence spectra of the diluted serum in the PMMa cuvette were acquired on a Hitachi F-4500 fluorescence spectrophotometer from 290 nm to 500 nm every 0.2 nm, at a rate of 240 nm per minute, with excitation at 280 nm, 2.5 nm slits, a 2 second integration time and a PMT bias of 700V. It is noted that while the spectrophotometers discussed here were used to provide some of the results discussed and illustrated, the present invention is not limited to only those spectrophotometers and may be used with multiple types of spectroscopic equipment.

Absorbance spectra were acquired on a Hitachi U-2001 UW-vis-NIR spectrophotometer with pure water in a PMMA cuvette as the reference sample. In one example, spectra were recorded every 1 nm from 260 nm to 500 nm at 400 nm per minute with medium detector response and a UV lamp change at 370 nm. The slit width was 2 nm. Every hour, system response was rechecked by measuring the absorbance of spectra of water; if the absorbance deviated from 0.000 by more than 0.01 near 400 nm, then the user baseline was redone.

Absorbance spectra were acquired in the limited wavelength range from 265 to 500 nm, to increase the data acquisition rate, although other ranges may be selected. In the exemplary embodiments, the absorbance wavelength range was not extended to 650 nm, which would have included secondary oxyhemoglobin and methehemoglobin peaks, because they were of negligible amplitude after the ideal dilution. In preliminary studies, there was no clear evidence of carotenes, xanthophylls, porphyrins or bilirubin in canine serum based on the absorbance spectra of samples diluted only to ¼ of their original concentration (see Example 2 below). This method can be adapted to other species by tailoring the dilution ratio and by including the reference spectra of other blood pigments as needed. For example, the ideal dilution ratio of chicken serum is closer to 1/20 and carotenes can be detected from the absorbance spectra.

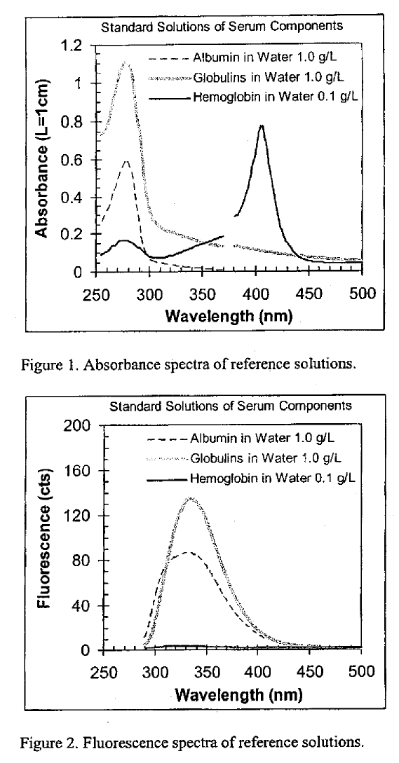

Single-solute aqueous reference solutions were prepared from fresh powders at concentrations of 1 g/L for canine albumin Cohn 5 (Sigma A9263), 1 g/L for canine globulins mainly a Cohn 4-1 (Sigma G7015) and 0.1 g/L for human hemoglobin including methemoglobin (Sigma H7379). For each solute, the final reference spectrum shown in FIG. 1 was the average from a series of solutions (with concentrations ranging from 20% to 200% of the standard concentration) after the spectra had been expressed as absorbance per unit of concentration. It should be noted that other reference solutions may be synthesized and evaluated. The reference solutions shown in FIG. 1 have distinguishable spectra that formed an independent basis for fitting dog absorbance spectra. Although all three components had a peak near 278 nm, hemoglobin also exhibited a stronger peak near 406 nm, globulins produced significant “tail” that gradually decreased from 300 to 500 nm, and albumin has no such tail or other peak.

Likewise, the fluorescence spectra of these reference solutions were also unique, as seen in FIG. 2. Hemoglobin emitted no significant fluorescence, nor did water or the PMMA cuvettes. Globulins produced bright narrow UV emission near 332 nm which was maximized using excitation at 280 nm. Albumin fluorescence intensity per solute concentration was lower near 332 nm, and its peak was broader, sot that albumin produced more emission near 300 nm than globulins. This difference in fluorescence peak shape provided additional information about the relative levels of albumin and globulins in fresh mixtures, which was incorporated by simultaneously fitting both normalized fluorescence spectra and absorbance spectra.

Absorbance peak amplitudes were proportional to solute concentration, as expected, so the observed absorbance spectra Abs(λ) of known mixtures and diluted serum samples were modeled using Equation (1) to generate a fit spectrum Abs_{fit}(λ) from a linear combination of the reference spectra for albumin Albu(λ), globulins Blob(λ), and hemoglobin Hem(λ), where n is the number of wavelengths 1 in the spectra. Later, a scattering background Scat(λ) was added to improve the fit by reducing the error E_{abs} between the observed and fir absorbance spectra, as defined by Equation (2). The coefficients A, G and H represent the estimated concentrations (in g/L) of albumin, globulins, and hemoglobin in the diluted solution, while S represents the magnitude of the scattering contribution to absorbance at 350 nm.

$$\begin{matrix}{Abs}_{fit} ( λ ) = \frac{A}{1.0} Albu ( λ ) + \frac{G}{1.0} Glob ( λ ) + \frac{H}{0.1} Hem ( λ ) + S \cdot Scat ( λ ) & ( 1 ) \\ {E}_{abs} ≡ \sqrt{\frac{{\sum }_{i = 1}^{n} \{ {( Abs ( {λ}_{i } ) - {Abs}_{fit} ( {λ}_{i} ) )}^{2} \}}{{\sum }_{i = 1}^{n} \{ Abs ( {λ}_{i} ) \}}} & ( 2 )\end{matrix}$$

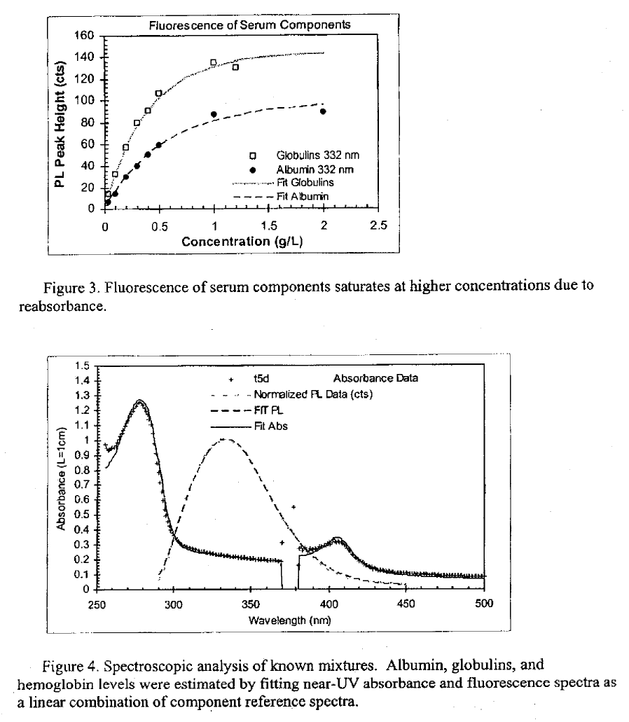

The fluorescence peak counts at 332 nm (PF_{albu} and PF_{glob}) of albumin and globulin solutions increased asymptotically with concentration (in g/L) due to reabsorbance, as seen in FIG. 3 and characterized by Equation (3). After dividing each original peak height, the normalized fluorescence spectra F_{albu}(λ) and F_{glob}(λ) from these single-solute solutions maintained their unique peak shapes for concentrations up to about 1 g/L. Fluorescent spectra were modeled by scaling each normalized reference spectra by the calculated peak heights, as shown by Equation (4). Then the error in the fluorescence fit E_{f} was calculated using Equation (5).

$$\begin{matrix}{PF}_{albu} = \frac{180 A}{1 + 1.2 {A}^{1.2}} and {PF}_{glob} = \frac{368 G}{1 + 1.8 {G}^{1.2}} & ( 3 ) \\ {F}_{fit} ( λ ) = {PF}_{albu} \cdot {F}_{albu} ( λ ) + {PF}_{glob} \cdot {F}_{glob} ( λ ) & ( 4 ) \\ {E}_{f} ≡ \frac{\sqrt{{\sum }_{i = 1}^{n} \{ {( \frac{F ( {λ}_{i} )}{F ( 332 nm )} - \frac{{F}_{fit} ( {λ}_{i} )}{{F}_{fit} ( 332 nm )} )}^{2} \}}}{{\sum }_{i = 1}^{n} \{ \frac{F ( {λ}_{i} )}{F ( 332 nm )} \}} & ( 5 )\end{matrix}$$

The diluted concentration estimates, A, G, H, and S were varied using a standard multi-parameter optimization routine, in order to minimize the sum of the e_{abs}+E_{f}, which yielded good fits of the absorbance and fluorescence spectra from multi-component mixtures, as demonstrated in FIG. 4. In this method, heavier weight was purposely placed on the absorbance spectra, because it scaled linearly with concentration.

To estimate the original concentrations A₀, G₀, H₀, S₀ and T₀ of albumin, globulins, hemoglobin, scattering and total protein, respectively, in the undiluted sample required input of the dilution ratio D, which was defined as the total volume divided by the small sample aliquot volume; D was typically 60. This method was calibrated against a series of standards that simulated dilute serum. The unique compositions of each standard mixture were planned in order to maximize the number of unique albumin, globulin, hemoglobin, and total protein concentrations over the ideal concentration range for good linear response from the Hitachi 2001 spectrometer. To obtain original concentration estimates that agreed with the known measured levels, the correction factors given by Equations (6-10) were used.
G₀=D(G−0.24_{g/L}) if G>0.64 g/L, otherwise G₀=D·G/1.6 (6)
H₀=D·H/1.28 (7)
T₀=D·(A+G)/0.94 (8)
A₀=T₀−G₀ (9)
S₀=D·S (10)

Another set of known mixtures was prepared with component concentrations near physiological levels, so that the original samples could be subjected to standard colormetric analysis by the blood lab at the Virginia-Maryland Regional College of Veterinary Medicine, while diluted aliquots from these samples were also analyzed using our spectroscopic method, for comparison.

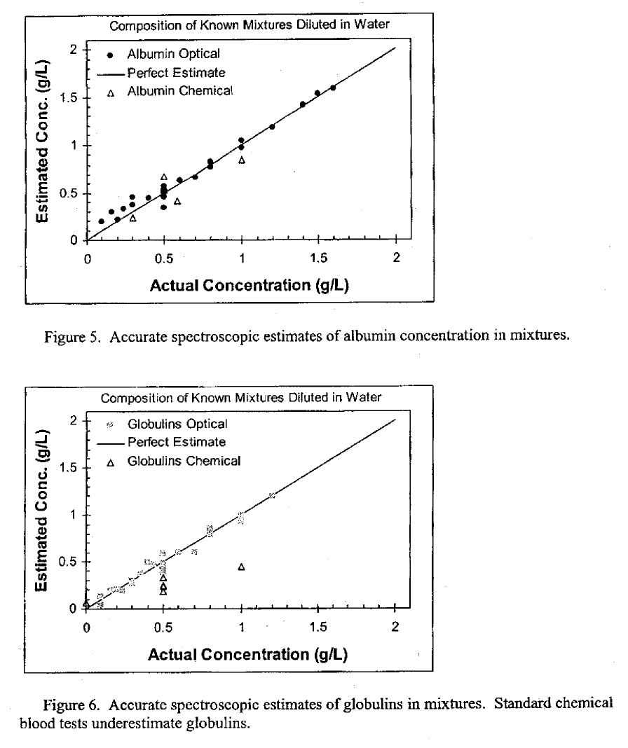

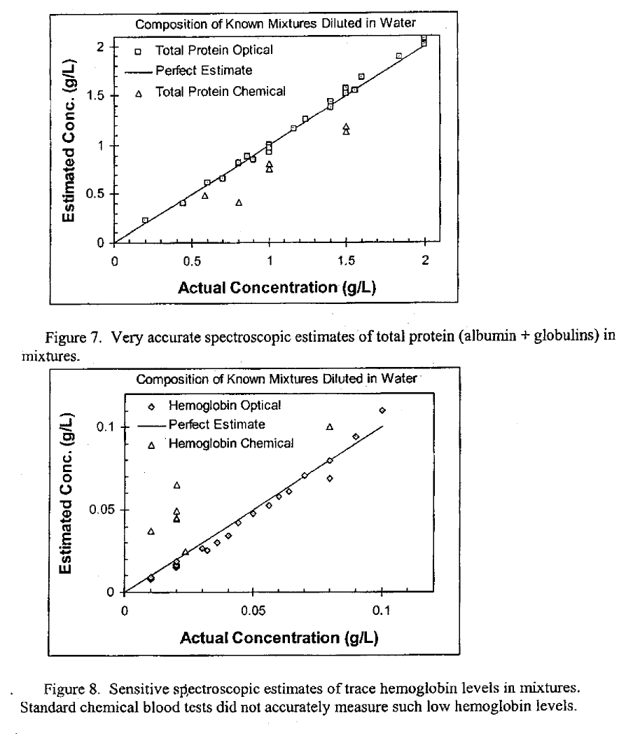

After applying these correction factors, the instant optical method was able to closely estimate albumin, globulins, total protein, and hemoglobin levels to within 10 percent of the actual levels in the multi-component mixtures, as shown in FIGS. 5-8. Compared to our optical method, chemical blood panel results were not as accurate, tended to underestimate globulins and total protein, and tended to overestimate hemoglobin levels. Such discrepancies in hemoglobin measurements are to be expected since the standard blood panel methods were designed to characterize whole blood, not serum. Therefore, this optical method is a particularly sensitive and accurate method of monitoring the very low free hemoglobin levels expected in serum.

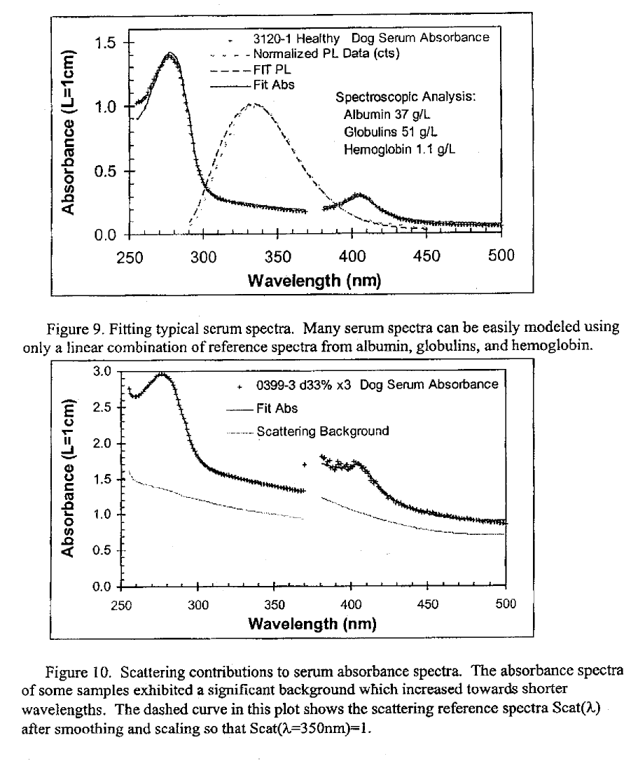

As an example of the efficacy of the present invention, canine serum was analyzed to monitor changes in patient's serum composition, and to develop cancer screening criteria. In a preliminary survey of 60 dogs, serum was collected from an extensive network of veterinary clinics in the New River Valley with each pet owner's permission and with a questionnaire, whereby the attending veterinarian documented each animal's health. All serum was drawn using standard vacutainers without anticoagulant. This allowed clotting to help separate red blood cells from the serum, and kept the extraction method uniform. Blood was centrifuged at low speeds to gently move the packed cell volume to the base of the tube with minimal rupture of the red blood cells. About 1 mL of serum was removed from the top of the tube and stored in the frozen state for several years. Before analysis, samples were thawed, gently mixed, and then diluted by adding 40 μL of serum to 2360 μL of deionized water in the PMMA cuvette. Diluted samples sealed in the PMMA cuvettes were gently tipped seconds before testing to maintain a homogeneous distribution of components, otherwise there was a tendency for globulins to settle near the bottom of the cuvette. Optical analysis was performed as described above, resulting in accurate modeling of serum absorbance and fluorescence spectra, as illustrated in FIG. 9.

To improve the quality of fit between modeled and measured spectra, a pseudo standard for serum scattering, Scat(λ), was derived from the residual absorbance spectra shown in FIG. 10. This baseline was smoothed and normalized so that Scat(λ=350 nm) equaled unity. Scat(λ) accounts for turbidity, perhaps from aggregated albumin complexes.

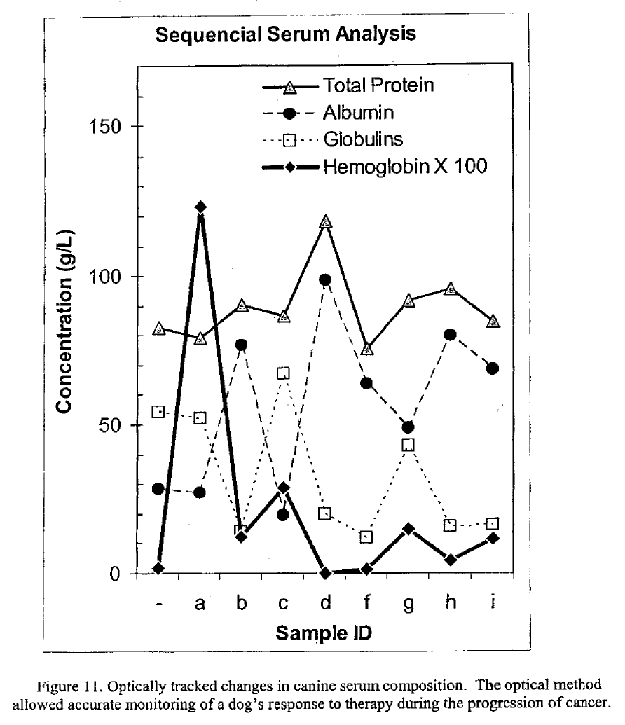

One of the most reliable applications of this technique is to optically monitor a patient's health. It is well known that the relative concentrations of albumin and globulins change with a patient's health status. In this case, we optically monitored a dog's response to therapy in order to track the progression or regression of cancer. FIG. 11 shows that significant changes in these serum components were optically tracked in an individual dog over the course of its treatment for cancer. Reduced albumin levels were often associated with elevated hemoglobin and globulin levels.

In practice, such a test could be performed as part of a routine check-up, to establish a healthy baseline pattern of serum components for an individual. Then, personal deviations from one's own baseline would be clear. This avoids the challenge of establishing general rules that account for many possible sources of serum compositional variation in different populations due to race, age, diet, medical history, gender, etc. Preliminary surveys of canine serum suggest that our technique can track the progression of other diseases, including renal failure, Addison's disease, and hypothyroidism.

Accurate measurements of albumin, globulins and hemoglobin levels in serum via our optical method enabled general cancer screening. When globulin levels were plotted versus albumin levels in FIG. 12, there was a set of coordinates with moderate albumin and globulin levels that described only healthy patients. Therefore, if the albumin level was between 40 and 80 g/L, and if the globulin level was simultaneously between 17 and 37 g/L, then the dog was labeled “safe.” However, if the hemoglobin level was below 0.2 g/L and the total protein level (albumin plus globulin concentration) was between 70 and 125 g/L, then the dog was labeled “suspect,” as seen in FIG. 13. If a dog's serum composition met the “suspect” criteria and did not meet the “safe” criteria, then further tests for cancer would be advised. Using these criteria, about 70% of dogs with cancer would be detected, and about 20% of those dogs flagged for further cancer testing would be expected not to show any clinical signs of cancer. This complex set of criteria effectively reduces the probability of mistakenly labeling a healthy dog as potentially having cancer. In medical terms, our test has a sensitivity of 70% and a specificity of 80%.

The optical test required minute quantities of blood serum (40 μL), about 1/10 the volume needed by chemical blood panels to monitor the same constituents. Since only one disposable pipette tip, one disposable PMMA cuvette and one blood vacutainer is required, the test was intrinsically economical. The test also used no consumable chemicals other than water, which allows albumin, globulin and hemoglobin to be measured from a single aliquot of serum, based on their unique absorbance spectra.

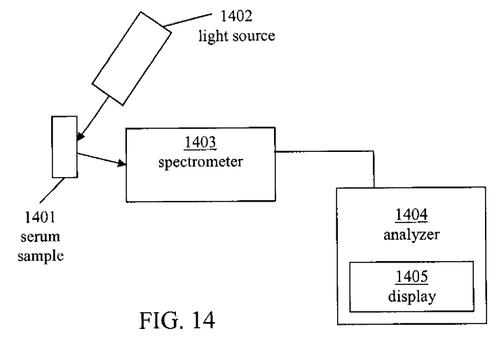

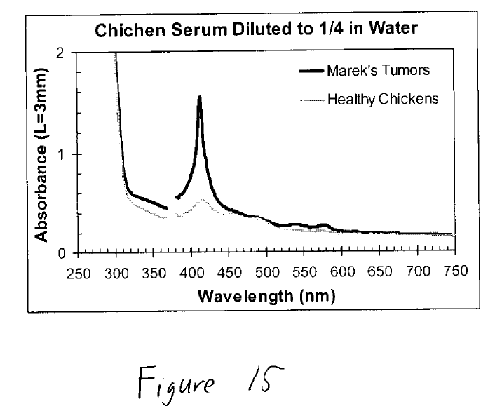

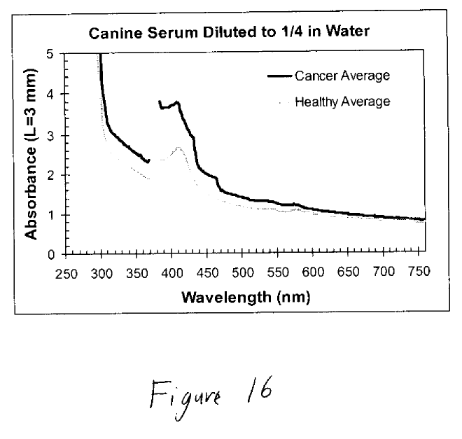

A representative system for performing analysis on a serum sample is illustrated in FIG. 14. The serum sample 1401 is exposed to a light source 1402 and light received from the serum sample is received by the spectrometer 1403. The light source used would depend on the type of spectroscopy, and the type of spectrometer may also be changed to accommodate the part of the spectrum to be examined. The spectrum-detected data is passed from the spectrometer to an analyzer 1404, where the above analysis is performed. The analyzer 1404 has a display 1405 that provides the analyzed data, as discussed above.

Further experiments that were done in developing the invention are described below in the Examples section.

Standard chemical blood panels generally use automated systems based on calorimetric reactions, in which proteins combine with a reagent (generally an acid or a dye) to form a colored complex. Within some concentration range, the increase or decrease in the absorbance of the complex at a specified wavelength is proportional to the target protein concentration. A highly specific reagent (alblumin blue) is used to test for albumin, while a more general binding reagent is used to measure total protein. See, for example, C. V. Sapan et al., “Colorimetric Protein Assay Techniques,” Biotechnology Applied Biocemistry (1999) vol. 29, pp. 99-108. Globulins are estimated from the total protein minus the albumin. By nature, only one of the these tests can be performed on a given aliquot of the sample, so that multiple aliquots are required to qualify multiple serum components; this multiplies to volume of sample needed to complete a set of tests.

Subtle variations in the amount of carbohydrates attached to a protein and in the folding or shape of the protein in a particular environment can affect its binding efficiency to the reagent, which reduces the accuracy of these tests and requires carefully made reference solutions that closely mimic the conditions of the prospective serum samples. Unless the attached carbohydrates and protein shape significantly alter the intrinsic absorbance spectra of each serum component, the optical method should not be sensitive to these common sources of variability, which may explain why the method estimated the composition of standard mixtures more accurately than calorimetric methods.

The high binding affinity of albumin for other serum pigments (like hemoglobin and bilirubin) implies that calorimetric measurements of these components would be intrinsically time sensitive, since these free proteins would gradually form bound complexes with very different chemical behavior, i.e. the bound complexes have reduced affinity for the colorimetric reagent. The method of using the intrinsic absorbance spectra of each component should be less sensitive to the degree of complex formation between them, analogous to the observation that “direct and indirect bilirubins have the same absorption curves in serum.” See, R. J. Henry et al., eds., Clinical Chemistry Principles and Techniques, 2^{nd} Ed., Harper & Row (1974) pp. 449, 1071-2, 1117, 1239.

There are numerous applications of general spectral deconvolution approach, whereby the constituent concentrations in a mixture are estimated using some form of least squares regression on various input vectors. Older methods input the absorbance values at a few key wavelengths including absorbance peaks, while modern computers have enabled the input of entire spectra. Modern optical analysis of biological mixtures has focuses on various forms of IR spectroscopy, given the greater detail of spectral features. See, for example, J. J. Workman, Jr., “Review of Process and Non-Invasive Near-Infrared and Infrared Spectroscopy: 1993-1999,” Applied Spectroscopy Reviews (1999) vol. 34, No. 1&2, pp. 1-89.

The fact that many serum proteins have an aromatic absorbance peak near 280 nm (see, for example, B. Leca-Bouvier et al., “Biosensors for Protein Detection: A Review,”Analytical Letters (2005) vol. 38, pp. 1491-1517) and the fact that the Soret band peak of hemoglobin can shift over time between 405 nm and 415 nm (for methemoglobin and oxyhemoglobin respectively, see R. J. Henry et al., eds., Clinical Chemistry Principles and Techniques, 2^{nd} Ed., Harper & Row (1974) pp. 449, 1071-2, 1117, 1239) may have discouraged researchers from deconvoluting near UV absorbance spectra in order to simultaneously estimate albumin, globulins and hemoglobin levels. Therefore, the specific correction factors needed to accurately estimate albumin, globulins and hemoglobin in serum have not been published; but we have presented them here. For accurate spectroscopic analysis of serum, it is widely understood that corrections must be made to account for turbidity. The residual fitting method is used to estimate this scattering background, rather than the constant, linear or power law methods that are usually used.

In addition, the present invention is not limited to the embodiments illustrated, but may also be expanded to other aspects. The system may be used to screen patients for cancer based on complex species-specific logic statements regarding the patient's albumin, globulins and hemoglobin. The present invention can also be applied to determining indirectly red blood cell wall strength or frailty, if the applied stress from the blood drawing technique is kept constant. The present invention may also be applied to detection of hemoglobin in urine, cerebrospinal fluid or other bodily fluids and thus be of use in diagnosing many diseases. It is further contemplated that the method used to estimate turbidity, as discussed above, may also be applied to monitoring the turbidity in ground and surface water, in cell cultures to estimate cell counts and in chemical reactions to monitor precipitation rates.

Having thus described several aspects of at least one embodiment of this invention, it is to be appreciated various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

### EXAMPLES

### Example 1

### Comparison of Absorption Spectra From Healthy and Cancerous Animals

Serum was obtained from chickens either infected with the neoplast forming Marek virus or from healthy chickens. The serum was diluted ¼ in water and an absorption spectrum was obtained using a Hitachi U-2001 UV-vis-NIR spectrophotometer with pure water in a PMMA cuvette as the reference sample. As can be seen in FIG. 15, serum from chickens with Marek's tumors had three peaks of higher absorbance than that from healthy chickens, at 415, 540 and 580 nm. All three of these peaks correspond to hemoglobin absorption peaks.

A similar experiment was done with serum from either healthy dogs or dogs having cancer. As can be seen in FIG. 16, a ¼ dilution in water had an absorbance approximately 5 times higher than that from chicken serum, causing increased distortion in the spectrum. Various dilutions were analyzed to determine a dilution that decreased the peak absorbance to less than 1.5. A dilution of 1/60 was found to give good results with less distortion. As can be seen in FIG. 2, serum from dogs having cancer had higher absorbances across the spectra, not just at the peak wavelengths. As can also be seen in FIG. 2, serum from dogs having cancer shows a significantly higher absorption peaks at 405 and 412 nm, among others.

### Example 2

### Comparison of Spectra to Standards

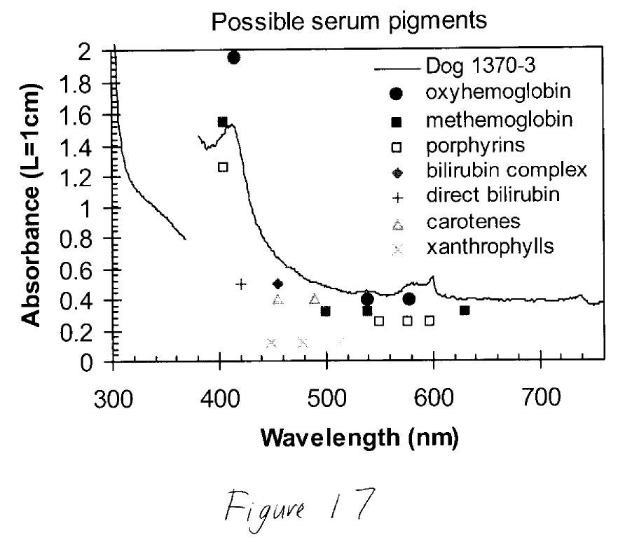

FIG. 17 shows an overlay of a spectrum obtained from a dog with cancer and the textbook values for absorbances of various serum proteins. This overlay suggests that oxyhemoglobin accounts for all three distinct peaks between 320 and 620 nm. It also suggests that the main peak at 412 nm is from oxyhemoglobin and the main peak at 405 nm is from methemoglobin. Samples from dogs did not show significant peaks corresponding to corotenes, xanthrophylls, porphyrins or bilirubin.

We claim:

1. A method for determining the presence and concentration of components in serum, the method comprising the steps of:
providing a serum sample from the subject;
performing optical analysis of the serum sample using a spectrometer to provide spectral data based on optical properties of the serum sample;
determining the concentrations of albumin, globulins and hemoglobin in the serum sample based on comparisons of the spectral data with reference spectra;
outputting the determined concentrations of the albumin, globulins and hemoglobin.

2. The method of claim 1, wherein the serum sample is obtained from blood.

3. The method of claim 1, wherein the serum sample is obtained from urine.

4. The method of claim 1, wherein the serum sample is obtained from cerebrospinal fluid.

5. The method of claim 1, further comprising:
comparing the determined concentrations of the albumin, globulins and hemoglobin with concentrations of the albumin, globulins and hemoglobin obtained previously;
evaluating a patient's response to treatment, based on the comparison of the determined concentrations with the concentrations of the albumin, globulins and hemoglobin obtained previously.

6. A method for diagnosing a disease in a subject, the method comprising the steps of:
providing a serum sample from the subject;
performing optical analysis of the serum sample using a spectrometer to provide spectral data based on optical properties of the serum sample;
determining the concentrations of albumin, globulins and hemoglobin in the serum sample based on comparisons of the spectral data with reference spectra;
outputting the determined concentrations of the albumin, globulins and hemoglobin; and
comparing the determined concentrations of the albumin, globulins and hemoglobin with concentrations of the albumin, globulins and hemoglobin obtained previously, wherein a change in the determined concentrations indicates the diagnosis of a disease.

7. The method of claim 6, wherein the serum sample is obtained from blood.

8. The method of claim 6, wherein the serum sample is obtained from urine.

9. The method of claim 6, wherein the serum sample is obtained from cerebrospinal fluid.

10. The method of claim 6, wherein the disease being diagnosed is cancer.

11. The method of claim 10, wherein the diagnosis of cancer is correlated with an increase in the determined concentration of hemoglobin in comparison with the concentration determined previously.

12. A method for developing a database for diagnosing a disease state in a subject, the method comprising the steps of:
providing a serum sample from a group of subjects diagnosis as having a disease state;
performing optical analysis of the serum sample using a spectrometer to provide spectral data based on optical properties of the serum sample;
determining the concentrations of albumin, globulins, hemoglobin and total protein in the serum sample based on comparisons of the spectral data with reference spectra;
outputting the determined concentrations of the albumin, globulins, hemoglobin and total protein; and
developing a database wherein the ratio of the determined concentrations of albumin, globulin, hemoglobin and total protein are correlated with the diagnosis of the disease state.

13. The method of developing a database for diagnosis a disease state of claim 12, wherein the ratio is the ratio of globulins to albumin.

14. The method of developing a database for diagnosis a disease state of claim 12, wherein the ratio is the ratio of hemoglobin to total protein.

15. A method for diagnosing a disease state in a subject, the method comprising the steps of:
providing a serum sample from the subject;
performing optical analysis of the serum sample using a spectrometer to provide spectral data based on optical properties of the serum sample;
determining the concentrations of albumin, globulins, hemoglobin and total protein in the serum sample based on comparisons of the spectral data with reference spectra;
outputting the determined concentrations of the albumin, globulins hemoglobin and total protein; and
comparing the ratio of determined concentrations of the albumin, globulins hemoglobin and total protein of the sample with the ratios of determined concentrations of the albumin, globulins hemoglobin and total protein present in the database of claim 12, wherein a correlation of the ratio of the sample with a disease state in the database gives a diagnosis of the subject having this disease state.

16. The method of diagnosis a disease state of claim 13, wherein the ratio compared with the database is the ratio of globulins to albumin.

17. The method of diagnosis of a disease state of claim 13, wherein the ratio compared with the database is the ratio of hemoglobin to total protein.

18. The method of claim 13, wherein the serum sample is obtained from blood.

19. The method of claim 13, wherein the serum sample is obtained from urine.

20. The method of claim 13, wherein the serum sample is obtained from cerebrospinal fluid.
